(19) United States
(12) Patent Application Publication
(10) Pub. No.: US 2006/0271302 A1
(43) Pub. Date: Nov. 30, 2006

(54) Method of Assessing Productivity of Lactating Animals Using Fitted Parameters to a Mechanistic Lactation Model

(76) Inventor: James Leonard Ehrlich, Argyle, NY (US)

Correspondence Address: Dr.James Leonard Ehrlich, Dairy Veterinarians Group, 832 Coot Hill Rd., Argyle, NY, 12809, US

(21) Appl. No.: 10/908,834

(22) Filed: May 27, 2005

(51) Int. Cl. G06F 19/00; G06Q 50/00; G06G 7/48

(52) U.S. Cl. 702/19; 703/11; 705/2

(57) ABSTRACT

An analytic method to evaluate performance of lactating animals by use of a parameterized algebraic model based on hypotheses about the physiology of lactation. Observed production data are fitted to the model to generate a set of parameter values which optimize compliance between model and data. Fitted parameter values summarize the lactation production of the animal or group. Inferences can be made from the fitted parameter values by referring to the physiologic assumptions made in deriving the model, and from their relationship with global or localized standards. Inferences can be used in managing health and productivity of the individual or group, for the development and testing of products which influence the health and productivity of lactating animals, and for evaluating genotype of animals or environmental conditions. Parameter values can be used recursively to improve the fitting process.

### FIELD OF THE INVENTION

This invention pertains to the management of milk-producing animals and methods to increase efficiency of milk production as well as research methods for studying dairy animals. Milk production through an individual lactation follows a generally predictable pattern (the lactation curve) with milk volume rising gradually after parturition to a peak value, then slowly declining until milking is halted (typically) to allow a rest period before another parturition initiates a new lactation. Production of milk components also changes in a related pattern. Many factors influence the exact shape and scale of individual lactation curves and thus overall productivity. It is a primary concern of dairy managers to maximize milk production, which is shown by the area under the lactation curve. Many health, nutritional, genetic, and environmental conditions influence the lactation curve. Analysis of lactation curves has wide applicability to management of dairy herds and development of products useful to dairy herds.

### BACKGROUND

Measurement of quantity and quality of milk produced by dairy animals, and use of that data in management decisions, has been commonplace for decades. An important use of numerical analysis of production data has been in the evaluation of genetic merit of animals, particularly of bulls used in artificial breeding programs. The same data and similar techniques have been used to improve management of dairy herds. Performance is often seen as the sum of genetic influences plus environmental influences, but many environmental influences are uncontrolled. Often uncontrolled environmental influences are lumped together as “random” effects.

Large data sets have been accumulated, and common practice has been to attempt adjustments to account for the major identifiable environmental effects, such as breed, body weight, and regional or seasonal effects. The term “Actual Productivity” (U.S. Pat. No. 5,351,644, “Method of Bovine Herd Management.” Robert W. Everett, 1994), has been used to describe an estimate of what production would be after normalization to account for certain known environmental factors. In this context, variables like age and days since parturition are considered to be environmental variables. U.S. Pat. No. 5,351,644 describes a “Test Day Model” generally applicable to factoring out known additive environmental effects in large sets of bovine production data.

We define “model” to mean the combination of an algebraic function with some hypothesis regarding the relationship of the function to observable physical entities. The algebraic function returns a predicted value for one or more physical measures when applied to one or more independent variables, such as time. It is “parameterized” if the function relies on a set of parameter values to control its behavior. The hypothesis may be general or specific, may be incomplete, and often is not explicitly stated. We believe this is consistent with the meaning used in U.S. Pat. No. 5,351,644. We further define a model as “mechanistic” when the hypothesis includes a mechanistic explanation of the algebraic function, even if that explanation is hypothetical or partial. Everett's “Test Day Model” is not mechanistic in that it models the effect of variables such as regional or seasonal effects without any effort to analyze or understand the mechanism of the effect on milk production. In distinction to a non-mechanistic model, a mechanistic model of production inherently contributes to understanding the mechanism of production, though the contribution may be subtle or indirect. Typically there is an attempt to imbue each parameter of a parameterized mechanistic model with a distinct meaning with respect to the hypothesis underlying the model.

Critical distinctions between this invention and U.S. Pat. No. 5,351,644 are our reliance on a parameterized mechanistic model, and use of a fitting engine which may rely upon information derived from historical data. The mechanistic model allows inferences to be drawn from fitted parameter values as well as enabling the possibility of using parameter values intelligently in devising or tuning the fitting engine. This allows a great deal more flexibility in how the invention may be used as well as decreasing the reliance on large quantities of training data.

This inventor, in a paper published in 1987 (Ehrlich, J.; A Screening Test for Production Evaluation in Dairy Herds. Bovine Practitioner 22:60), described a method for analyzing lactational performance based on linear fitting of a polynomial non-mechanistic lactation model to observed data in a way that anticipates the approach taken by this invention. Critical advances incorporated in this invention include the use of a mechanistic model, and improved fitting methods.

The method suggested by Ehrlich in 1987 is just one of a number of techniques generally called “lactation curve analysis”. These may include use of measures such as “peak milk” (the highest daily milk yield during the lactation), “persistency” (a measure of the relative rate of decline in production in the later part of the lactation curve, measured in several different ways), and various measures of overall scale such as “150-day adjusted corrected milk”, which is intended to estimate what production will be or would have been on the 150^{th} day of lactation form one or more measurements at other times. None of these use a mechanistic model.

We use the terms “health”, “productivity”, and combinations almost interchangeably. Each term, “health”, and “productivity”, is meant to define a set of attributes, with a great deal of overlap between the two sets, and choice of terms often dependent only on a person's point of view. We use the term “health or productivity” to mean the union of the two sets of attributes, for which there is no single English word.

### SUMMARY OF THE INVENTION

The goal of the process constituting this invention is to calculate a small set of parameter values which individually and in combination carry meaning related to the lactational performance of one or more dairy animals. Parameter values may be used to make inferences about physiologic state or environmental conditions, and also as feedback in an iterative process to improve accuracy of subsequent estimates.

The process can be summarized as follows:
(1) A parameterized mechanistic model is selected from an existing library or derived de novo.
(2) A fitting engine is selected from an existing library or designed de novo. The fitting engine must take production data, and possibly additional inputs, to generate a set of parameter values for the model selected in step 1 such that the fitted parameter values in some sense optimize compliance between observed production data and the model.
(3) Observed data are fed into the fitting engine generating one or more sets of fitted parameter values.
(4) Inferences are made about the health or productivity of animals contributing the input data based on knowledge of the model and characteristics of the fitting engine, with possible assistance from statistical methods or artificial intelligence.

### Preferred Embodiment

The preferred embodiment of this invention models daily milk production expressed as pounds per day. Our primary hypothesis conceptualizes milk production as the product of a number of theoretical milk producing units within the udder, each producing a constant quantity of milk per unit of time. This allows us to model total production by modeling the population dynamics of our theoretical production units. While it is tempting to imagine a correspondence between the hypothetical production units and mammary secretory cells, this is unnecessary to our method. The “number of theoretical milk producing units” turns out to be fractional in this implementation, which is immaterial to function of the invention.

To model the population of production units, we define a “Construction Function”, “C(t)”, to model appearance of new units in the population as a function of time, “t”. We refer to the physiological process modeled by the Construction Function as the “Construction event”. Similarly, we define a “Destruction Function”, “D(t)”, modeling removal of units from the population. There is no “Destruction event” in our preferred embodiment because destruction is modeled as a continuous process rather than a discrete event. Finally we define a “Scaling Constant”, “a”, that models production per unit per unit time. To calculate predicted production on a given day, we want to know the total number of units constructed on or before that time, so define a “Build Function”, “G(t)” which we can calculate as the integral from minus infinity to t of the Construction Function. To standardize scale of construction and destruction, we will design our functions so that both G(t) and D(t) return values between zero and 1 for values of t in our range of interest. We then define total daily milk yield on day t as the product of the Scale Parameter, the Build Function and the Destruction Function, Y(t)=a·G(t)·D(t).

In our preferred embodiment we further hypothesize that the Construction Function can be modeled by a single Gaussian event centered near parturition, and that the Destruction Function follows first-order decay kinetics. Our Construction function will require two parameters. Parameter b, which we call the “Build parameter”, defines the width of the Gaussian Construction event (in a way that is equivalent to standard deviation of a Normal curve). Parameter c, which we call the “Offset parameter”, defines the offset in time of the peak of the Construction event from the day of parturition. Our Destruction Function requires a single parameter, d, which we call the “Decay parameter”, the first-order decay constant. Thus we may summarize the meaning of our four parameters as follows:

Parameter “a”, the Scale parameter, models overall productivity. Changing the Scale Parameter will result in a linear change in daily production, for each day within the lactation and for total production over the lactation. It is expressed as “pounds per day”, or similar units. This may also be seen as what each theoretical milk-producing unit produces in one day. It follows that the Scale Parameter cannot be negative, and since our preferred implementation implements the Growth and Destruction functions to return values between zero and 1, the Scale Parameter expresses the maximum theoretical daily production (which is considerably higher than the actual peak of typical lactation curves).

Parameter “b”, the Build parameter, controls the steepness of the post-parturient rise in milk production. If the Gaussian Construction event is narrow (i.e. low b parameter) there will be a steep rise in milk production. It is expressed in units of time, “days”. For a Gaussian Construction function, b is analogous to standard deviation of a Normal curve, and the same thumb rules about area under the curve apply as for standard deviation, for example that 69% of Construction occurs within plus or minus b days from the peak. It follows that the Build Parameter cannot be negative.

Parameter “c”, the Offset parameter, shifts the Construction event (and therefore the post-parturient rise in production) in time with respect to the date of parturition. It is expressed in units of time, “days”. It may be seen as the offset between date of parturition (t=0) and date of peak udder development. It follows that the Offset parameter may be positive or negative.

Parameter “d”, the Decay parameter, controls the rate of decline of production. It is expressed in units of inverse time, “days⁻¹”. It follows that the Decay Parameter is expected to be positive, based on accepted ideas of normal lactational physiology. Negative values might occur if a method were discovered to reverse normal senescence, and it is possible that agents such as growth hormones might best be modeled as a negative influence on the Decay Parameter, even to the point where it could attain a negative value.

To model normal bovine lactation curves which typically rise to a peak about 50 days after parturition then decline, our parameters will be selected so that the Construction event is largely complete before day 50 and centered near parturition (t=0). After about day 50 the Destruction Function begins to dominate the population dynamics of our hypothetical units.

To complete our algebraic model in the preferred embodiment, we make a compromise to gain computational speed. Our hypothesis postulates a Gaussian Construction event, but the preferred embodiment uses a simplified algebraic approximation, taking advantage of the fact that the peak of the Construction event is expected to be at or near parturition. Under common conditions, we are not very concerned with production in the few days between day 0 and day c, so we can live with a function that closely approximates a Gaussian curve in the range t>c.
C(t)=e^{-(t-c)/b}/(2·b)

We calculate the Growth Function G(t) by integrating C(t) symbolically.
G(t)=1−e^{-(t-c)/b}/2

The Decay Function uses the common first-order decay function with a Decay Parameter, d.
D(t)=e^{-dt}

Finally, we add the Scalar Parameter to make an algebraic formula describing predicted daily milk yield as a function of time. This completes our model.
Y(t)=a·G(t)·D(t)=a·(1−e^{-(t-c)/b}/2)·e^{-dt}

Nonlinear curve fitting is a field of active development in mathematics, and in selecting among available fitting algorithms there are many tradeoffs. This inherent difficulty cannot be ignored, but by having a variety of methods tuned to particular situations available, a skilled practitioner can select the most appropriate method for a particular need, or develop a new fitting algorithm. Our preferred embodiment includes several scenarios. In all of them we refer to the 4-parameter model described above with parameters expressed as {a,b,c,d}.

### Preferred Embodiment

### USAGE EXAMPLES

### Example 1

We assume a particular herd has established herd-specific historical norms for the parameters of {100, 15, 7, 0.0015}. An individual cow produces 70 pounds of milk on the 100^{th} day of lactation. Since we only have a single data point, we can solve for a maximum of one parameter value. We chose to fix b,c, and d parameters at normal values for the herd and fit only the scale parameter, “a”. This can be done by solving for a using t=100, Y(t)=70, and our fixed values for parameters b,c, and d.
a=((1−e^{-(t-c)/b}/2)·e^{-dt}))/Y(t)=81.4 pounds

This is equivalent to saying performance was 81.4/100 or 81.4% of the herd norm. As with any fitted parameter set, a prediction of production on some future day, t, can be made by solving for Y(t) using the fitted parameters ({81.4, 15, 7, 0.0015}). If more than one input point is available for fitting, linear curve fitting methodology can be used to fit the “a” parameter (which is linear with respect to fixed b,c, and d parameters).

### Example 2

A researcher wishes to develop normal parameter values stratified by some variable such as region, breed, or a management factor; or perhaps stratified by herd as might be used to generate herd-specific norms as used in Example 1. Minimizing opportunities for the fitting engine to introduce bias is more important than computational speed, so a genetic algorithm (such as “simulated annealing”) is chosen. Data subsets of multiple daily milkweights drawn from a single lactation are fitted, and a database of fitted parameter values for each lactation is assembled. This database is then analyzed by standard techniques of multivariate statistics.

### Example 3

A consultant is asked to investigate a perceived production problem in a dairy herd. He submits production data to a commercial service which generates a database of fitted parameter values using a proprietary and secret fitting algorithm, along with statistics summarizing the parameter values and comparing them to benchmark values. It is not necessary that the consultant know details of the fitting algorithm, as long as the performance has been validated (perhaps by demonstrating excellent ability to predict future production in past lactations). He discovers that the herd in question has abnormally high variability in the Build parameter, so concludes he should focus his investigation on the management of pre-fresh and early-lactation cows, and particularly on factors which may lead to inconsistency. If, on the other hand, the Decay parameter was abnormally large, he would concentrate on factors (such as chronic mastitis, for example) that have been associated with what are sometimes called “persistence” problems.

### Example 4

A nutritionist wishes to evaluate the addition of a feed ingredient which he hopes will increase milk production. He submits data to the service as in Example 3, which calculates that the summed effects of normal lactation dynamics (as encapsulated in the model) would result in a drop in total milk production of 0.2 pounds per cow over the following week, with a 95% confidence range of −1.2 to +0.8 pounds. Actual milk production increases by 1 pound, so he estimates the effect of the ingredient as increasing production by 1.2 pounds per day, and that the increase is statistically significant.

### Example 5

A researcher wishes to evaluate a bull offered for artificial breeding service. He has access to a large database of fitted parameter values generated by the researcher in Example 2, and also that researcher's estimates of covariance between individual parameters and certain environmental variables. He devises a customized fitting engine which normalizes parameter values by subtracting predicted environmental effects, with the residual seen as a purified measure of genetic factors. He further enhances the fitting engine by addition of a feedback mechanism which stratifies fitted parameter sets by the cow's sire, calculates covariance between parameter sets and each sire, then uses the resultant values to estimate the genetic value of each cow who has a known sire. With this, he can refine estimates of environmental effects by subtracting newly quantified genetic effects and iterative recalculation, continuing to work recursively as records and computing time allow. He publishes his result as an expected genetic transmitting power of each bull with respect to each parameter.

### Example 6

A researcher observes that the ratio of protein to fat in milk varies independently from milk volume, and that the variation is somewhat regular with respect to time since parturition. He devises a model using methods similar to those described in our preferred embodiment, and adapts fitting methods. He then studies the relationship between fitted parameter values and management conditions, like the researcher in Example 2.

What is claimed is:

1. A method for analysis of health or productivity of lactating animals comprising the steps: (a) selecting a measure of health or productivity to be analyzed,
(b) selecting a model which includes an algebraic function controlled by a parameter set of one or more parameter values, which function describes normal change in said measure over time and which model is based on a theoretical or practical understanding of the physiology of lactation and which model is constructed so that said parameter set may be interpreted with respect to said understanding,
(c) collecting data on said measure,
(d) applying a fitting algorithm to generate parameter values for said function that optimize compliance between said data and values predicted by said model.

2. A method for analysis of health or productivity of lactating animals in accordance with claim 1 wherein said model is developed as part of the process.

3. A method for analysis of health or productivity of lactating animals in accordance with claim 1 wherein said parameter sets are interpreted in the context of their relationship with said model whereby the effect of an intervention may be evaluated or future performance predicted.

4. A method for analysis of health or productivity of lactating animals in accordance with claim 1 wherein statistical manipulation or artificial intelligence are used to aid interpretation of said parameter values.

5. A method for analysis of health or productivity of lactating animals in accordance with claim 1 wherein said parameter sets are used to enhance performance of said fitting algorithm.

6. A method of research where a database including said parameter sets is generated in accordance with claim 1 and the relationship between variables and said parameter sets is studied.

7. A method of research in accordance with claim 1 wherein said parameter sets are used to estimate the genotype of individuals or their ancestors.

8. A method of research in accordance with claim 1 wherein said parameter sets are used to predict future production of individuals or groups.

9. A method of research in accordance with claim 1 wherein said parameter values are used to estimate environmental effects influencing individuals or groups.

10. A method of research in accordance with claim 1 wherein said parameter values are used in the evaluation of a response to some product, intervention, or change in management.

11. A method of research in accordance with claim 1 wherein said parameter values are used to assist management decisions such as culling or mating of individual animals, changes in feeding, or other changes intended to influence lactational performance.

12. A method of research where individual databases including said parameter sets in accordance with claim 1 are combined, compared, or linked.

13. A method of research in accordance with claim 1 wherein production of whole milk or production of individual milk components such as butterfat, protein, lactose, or somatic cells constitute said measure.

14. A method of research in accordance with claim 1 wherein relative production of milk components constitutes said measure.

15. A method of research wherein data is submitted by electronic means to a service which returns said parameter sets in accordance with claim 1.

16. A method for modeling health or productivity of lactating animals comprising the steps of: a) selecting a measure of health or productivity to be analyzed,
b) construction of a model which includes an algebraic function controlled by a set of parameter values, which function describes the shape of a curve representing said measure over time for a lactation and which model is based on a theoretical or practical understanding of the physiology of lactation and which model is constructed so that said parameter values may be interpreted with respect to said understanding.

17. A method for modeling health or productivity of lactating animals comprising the steps of: a) selecting a measure to be analyzed,
b) construction of a model which includes an algebraic function controlled by a set of parameter values, which function describes the shape of a curve representing said measure with respect to an independent variable and which model is based on a theoretical or practical understanding of the physiology of lactation and which model is constructed so that said parameter values may be interpreted with respect to said understanding.
